(19) United States
(12) Patent Application Publication
(10) Pub. No.: US 2006/0166178 A1
(43) Pub. Date: Jul. 27, 2006

(54) Device and method for voicing phonemes, and keyboard for use in such a device

(75) Inventor: Ademar Odin Haron Driedijk, Ter Aar (NL)

Correspondence Address: THE WEBB LAW FIRM, P.C., 700 KOPPERS BUILDING, 436 SEVENTH AVENUE, PITTSBURGH, PA, 15219, US

(73) Assignee: Klankie B.V., Woerden (NL)

(21) Appl. No.: 10/542,126

(22) PCT Filed: Jan. 12, 2004
(86) PCT No.: PCT/NL04/00020

§ 371 Date: Dec. 1, 2005

(30) Foreign Application Priority Data
Jan. 16, 2003 (NL) 1022412

(51) Int. Cl. G09B 5/00

(52) U.S. Cl. 434/307 R

(57) ABSTRACT

The invention relates to a device for voicing phonemes, comprising: a keyboard, which keyboard comprises at least one support structure and a plurality of keys connected to the support structure, wherein each key of at least a number of keys is designated with at least one linguistic symbol, an electronic processing unit connected to the keyboard for recording keystrokes, and sound-producing means connected electronically to the processing unit. The invention also relates to a keyboard for use in such a device. The invention further relates to a method for voicing phonemes by means of such a device.

The invention relates to a device for voicing phonemes, comprising: a keyboard, which keyboard comprises at least one support structure and a plurality of keys connected to the support structure, wherein each key of at least a number of the keys is designated with at least one linguistic symbol, an electronic processing unit connected to the keyboard for recording keystrokes, and sound-producing means connected electronically to the processing unit. The invention also relates to a keyboard for use in such a device. The invention further relates to a method for voicing phonemes by means of such a device.

Children and non-native persons generally first learn to use a particular language verbally, before they learn to read and write this language. The use of information and communication technology (ICT) can improve education and the leaning process and provide an added educational value. (Language) skills can thus for instance be taught by means of ICT, whereby ICT does in fact assume a ‘teacher-substitute’ role in the educational process. Computers are generally already being applied on a large scale for educational purposes. The conventional computers are not however the most ideal aid for teaching children and non-native persons reading skills and writing skills of a particular language. It is at present therefore relatively difficult for such people to learn to read and write using conventional ICT-related devices.

The invention has for its object to provide an improved device, using which illiterate people can learn to read and write in relatively effective manner.

The invention provides for this purpose a device of the type stated in the preamble, characterized in that the processing unit is provided with conversion means for converting at least one recorded keystroke into a signal for a phoneme corresponding to the linguistic symbol of this at least one keystroke, wherein the sound-producing means are adapted for voicing of the phoneme. The above stated device has the great advantage that using the device a direct connection can be made between the linguistic symbol shown on a key for visual representation of a phoneme and the (acoustic) voicing of this phoneme. In this manner illiterate people can link an auditory phoneme to a visual representation of this phoneme in relatively efficient manner. An illiterate person remembering which linguistic symbol is linked to which phoneme can take place relatively quickly using the device according to the invention. The conversion means can be of very diverse nature. The conversion means can be formed by both hardware and software, as well as by a combination of both. It is noted that physical contact between different components forming part of the device according to the invention is not essential. Wireless communication for instance can thus also be envisaged. Conversely, it is likewise possible to embody the device according to the invention as a completely integrated system.

In a preferred embodiment at least one phonetic symbol is shown on each of at least a number of the keys of the keyboard. The phonetic symbol can for instance be formed by a single letter or by a combination of letters. Since phonetic symbols are generally more closely related to a determined phoneme than conventional letters, in particular capitals, it will generally be possible to accelerate the educational process considerably. The phonetic symbols do not necessarily have to be shown on the keys. What is essential is that a person can see unambiguously that a pictured phonetic symbol is associated with a specific key. It is noted that a linguistic symbol is understood to mean any symbol used in writing to indicate a phoneme or combination of phonemes. Linguistic symbols can for instance thus be understood to mean: capitals, lower case letters, phonetic characters or symbols, digits and/or numbers, and optional picturing for the purpose of designating one or more phonemes.

The processing unit is preferably connected electronically to visualizing means for visualizing the phonemes associated with the keystrokes. The visualizing means can for instance be formed by a screen, in particular a monitor. In addition to hearing a phoneme, a person can thus also see how a phoneme can be visualized, optionally phonetically, or for instance in which word (and associated image) such a phoneme occurs. It will be apparent that numerous other possibilities remain for direct and/or indirect visualization of the phoneme.

In a preferred embodiment the conversion means are adapted for conversion of a plurality of entered keystrokes into a single signal corresponding with these keystrokes. In this manner the plurality of entered keystrokes can be ‘pronounced’ (voiced) by the device as a single connected letter combination, in particular a word. An illiterate person can therefore not only learn to read and write linguistic symbols, but also words and possibly sentences.

In another preferred embodiment the processing unit is connected electronically to at least one database in which is stored a plurality of words and phonemes corresponding with these words. The entered keystrokes can then be compared to the words stored in the database, whereafter these words can further be voiced by the sound-producing means. In this manner an illiterate person can learn to read and write the (most basic) words of a particular language.

The processing unit is preferably formed by a central processing unit (CPU). The device can thus be formed by a special computer adapted for hardware and/or software-aided voicing of phonemes associated with inputted linguistic symbols.

In another preferred embodiment the sound-producing means are formed by at least one loudspeaker. Conventional loudspeakers can be relatively inexpensive and are generally of sufficient quality to achieve clear voicing of the phonemes.

The device is preferably provided with at least one information carrier, which information carrier is provided with the conversion means. The information carrier can for instance be formed by a (hard) disc, cd, dvd and so on. The conversion means are then digitally available on the information carrier and in particular are made up of a series of instructions to the processing unit. In the present preferred embodiment the conversion means are thus formed by a software module.

The invention also relates to a keyboard for use in such a device.

The invention further relates to a method for voicing phonemes by means of such a device, comprising the steps of: A) a user pressing at least one key, B) the processing unit recording the keystroke, C) converting the keystroke into a signal for a phoneme corresponding with the keystroke, and D) acoustically producing the phoneme. Advantages of such a method have already been described above. It is not essential however to follow the above stated steps in the described sequence. It is thus also possible for instance to first perform step D), whereafter the user must enter the linguistic symbol associated with the produced phoneme as according to step A). What is essential is that a link is made between a linguistic symbol and a phoneme associated with this linguistic symbol, and vice versa.

In a preferred embodiment a plurality of keys are pressed during pressing of at least one key by the user according to operating step A), whereafter the entered keystrokes are converted as according to operating step C) into a single signal for a phoneme corresponding with the keystrokes. Words and even sentences can thus be voiced when operating step D) is carried out.

In another preferred embodiment, the method is provided with an operating step E), comprising of comparing the entered keystroke with words included in a database (vocabulary) before the phoneme is produced acoustically as according to operating step D) and after the keystroke is recorded as according to operating step B). A check is thus carried out by the device as to whether the entered keystroke or keystrokes corresponds or correspond with a word from the vocabulary included in the database. Checking of the entered keystrokes can be useful in preventing forming of non-words.

In a final preferred embodiment, a delay of a determined time duration is present between recording of the keystroke by the processing unit as according to operating step B) and converting of the keystroke into a signal for a phoneme corresponding with the keystroke as according to operating step C). The user, normally an illiterate person, is thus given the opportunity to enter a subsequent linguistic symbol within the time duration, before a previously entered symbol is voiced. In this manner the user can form words, which can then be pronounced (voiced).

The invention will be elucidated on the basis of non-limitative exemplary embodiments shown in the following figures. Herein:

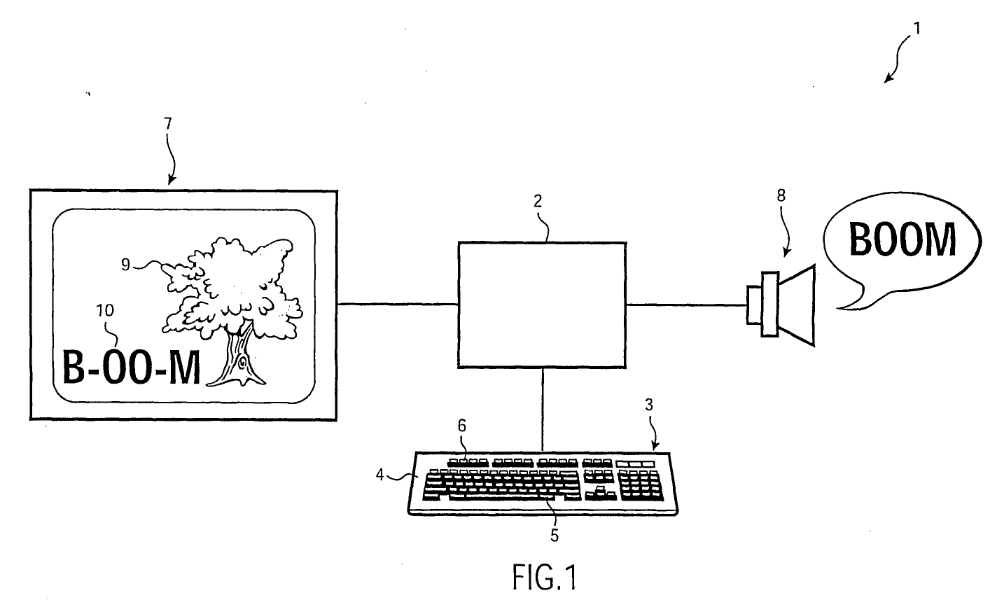

FIG. 1 shows a schematic representation of a device according to the invention, and

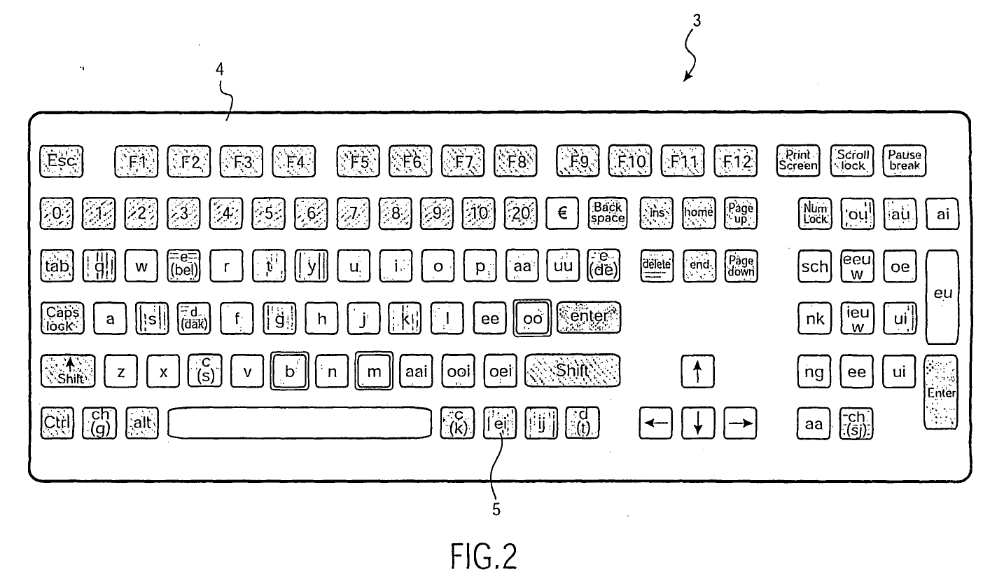

FIG. 2 shows a top view of a keyboard for use in the device according to FIG. 1.

FIG. 1 shows a schematic representation of a device 1 according to the invention. In the shown embodiment the device 1 is specifically adapted for the Dutch language. Device 1 comprises a central control unit 2 and a keyboard 3 connected to control unit 2. Keyboard 3 comprises a support structure 4 for a plurality of keys 5. Substantially each key 5 is provided with a linguistic imprint 6, wherein on a number of the keys 5 the imprint 6 is formed by a phonetic symbol. Keyboard 3 is further elucidated in FIG. 2. Control unit 2 is also coupled to a monitor 7 and a loudspeaker 8. By means of keyboard 3 a user, in particular an illiterate person, can press a key 5 or a plurality of keys 5 provided with a phonetic symbol. The entered keystrokes am recorded by control unit 2. The phonetic symbols associated with the entered keystrokes are then converted by control unit 2 into a signal which is transmitted to loudspeaker 8, where the signal is converted into an acoustic phoneme. On the other hand, the keystrokes recorded by control unit 2 are compared to a word included in a database (not shown). If the entered keystrokes are recognized by control unit 2 as being a word present in the database, data relating to this specific word can then be visualized on monitor 7. In the shown embodiment the word ‘boom (tree)’ is entered by the user After being entered, the word ‘boom’ is ‘pronounced’ by speaker 8 and an image 9 of a tree is also shown on monitor 7, as well as a breakdown of the word ‘boom’ into visualized basic phonemes 10, i.e. “b-oo-m”. It will be apparent that the shown embodiment is only an example, wherein this example then serves as an example for the Dutch language. It is therefore also possible to envisage adapting the device 1 for languages other than Dutch. What is however essential is that the writing skills and reading skills of a particular language can be mastered in relatively simple manner by means of voicing of entered (phonetic) symbols.

FIG. 2 shows a top view of Dutch keyboard 3 for use in device 1 of FIG. 1. As already stated, keyboard 3 comprises a support structure 4 on which a plurality of keys 5 is arranged. Keys 5 are substantially provided with an imprint 6, wherein on a number of the keys 5 the imprint 6 is formed by phonetic symbols. The structure and lay-out of keys 5 on support structure 4 bears a very great resemblance to conventional keyboards so as to facilitate the transition from the shown keyboard 3 to a conventional keyboard. The phonetic symbols “b”, “oo” and “m” are here shown in a double-line box, since these keys 5 are pressed to have the word ‘boom’ visualized on the one hand and voiced on the other by device 1. Keys 5 are shown marked in order to elucidate the functionality of different ‘key groups’. An overview is shown hereinbelow of the different categories and the associated markings on keyboard 3.
[symbol] General (conventional) keyboard functions
[symbol] Numbers
[symbol] Phonetic symbol with a phoneme corresponding with the phoneme of another phonetic symbol
[symbol] Phonetic symbols wit a unique phoneme
[symbol] Phonetic symbol having multiple phonemes
[symbol] Phonetic symbol with a phoneme corresponding with the phoneme of another phonetic symbol, wherein the phonetic symbol also has multiple phonemes
[symbol] Currency keys, arrow keys and space bar
[symbol] Backspace and enter key

Research results have shown that the above stated lay-out of keyboard 3 is very suitable for educational purposes. In this manner an individual educational keyboard 3 can be designed for each language. In addition to voicing of (a combination of) letters, it is also possible to voice digits and/or numbers using the shown keyboard 3 according to the invention. It is so possible to enter a multi-digit number by successively pressing a plurality of keys 5 provided with a digit. The successive pressing of key 5 “7” followed by key 5 “8” will thus be voiced by device 1 as being the number “78”. However, the number “78” can of course also be formed by letters (instead of digits) and then be voiced pronounced) by device 1. It is noted that conventional keyboards can also be applied. The phonetic symbols can then be omitted or added, for instance via a pre-printed overlay sheet. What is essential however is the voicing of linguistic symbols shown on the keyboard.

1-14. (canceled)

15. A device for voicing phonemes, comprising:
a keyboard, which keyboard comprises at least one support structure and a plurality of keys connected to the support structure, wherein each key of at least a number of keys is designated with at least one linguistic symbol,
an electronic processing unit connected to the keyboard for recording keystrokes, and
sound-producing means connected electronically to the processing unit, wherein the processing unit is provided with conversion means for converting at least one recorded keystroke into a signal for a phoneme corresponding to the linguistic symbol of this at least one keystroke, wherein the sound-producing means are adapted for voicing of the phoneme.

16. The device as claimed in claim 15, wherein the at least one phonetic symbol is shown on each of at least a number of the keys of the keyboard.

17. The device as claimed in claim 15, wherein the processing unit is connected electronically to visualizing means for visualizing the phonemes associated with the keystrokes.

18. The device as claimed in claim 15, wherein the conversion means are adapted for conversion of a plurality of entered keystrokes into a single signal corresponding with these keystrokes.

19. The device as claimed in claim 15, wherein the processing unit is connected electronically to at least one database in which is stored a plurality of words and phonemes corresponding with these words.

20. The device as claimed in claim 15, wherein the processing unit is formed by a central processing unit (CPU).

21. The device as claimed in claim 15, wherein the sound-producing means are formed by at least one loudspeaker.

22. The device as claimed in claim 15, wherein the device is also provided with at least one information carrier, which information carrier is provided with the conversion means.

23. A keyboard for use in a device as claimed in claim 15.

24. A method for voicing phonemes, comprising the steps of:
A) a user pressing at least one key,
B) a processing unit recording the keystroke,
C) converting the keystroke into a signal for a phoneme corresponding with the keystroke, and
D) acoustically producing the phoneme.

25. The method as claimed in claim 24, wherein a plurality of keys are pressed during pressing of at least one key by the user according to operating step A), whereafter the entered keystrokes are converted as according to operating step C) into a single signal for a phoneme corresponding with the keystrokes.

26. The method as claimed in claim 25, wherein the phoneme forms a word.

27. The method as claimed in claim 24, wherein the method is provided with an operating step E), comprised of comparing the entered keystroke with words included in a database before the phoneme is produced acoustically as according to operating step D) and after the keystroke is recorded as according to operating step B).

28. The method as claimed in claim 24, wherein a delay of a determined time duration is present between recording of the keystroke by the processing unit as according to operating step B) and converting of the keystroke into a signal for a phoneme corresponding with the keystroke as according to operating step C).
